(19) United States
(12) Patent Application Publication
(10) Pub. No.: US 2019/0260119 A1
(43) Pub. Date: Aug. 22, 2019

(54) MAGNETO-DIELECTRIC ANTENNA

(71) Applicant: Rogers Corporation, Chandler, AZ (US)

(72) Inventor: Karl E. Sprentall, Medford, MA (US)

(21) Appl. No.: 16/233,496

(22) Filed: Dec. 27, 2018

Related U.S. Application Data
(60) Provisional application No. 62/611,747, filed on Dec. 29, 2017.

(51) Int. Cl. H01Q 1/38; H01Q 9/04; H01Q 9/16; H01Q 21/24; H01Q 21/06; H01Q 21/00; H01Q 1/52; H01Q 1/24

(52) U.S. Cl. CPC H01Q 1/38; H01Q 9/0421; H01Q 9/16; H01Q 21/24; H01Q 1/243; H01Q 21/061; H01Q 21/0025; H01Q 1/523; H01Q 9/0457

(57) ABSTRACT

An antenna system, includes: a signal feed, a magneto-dielectric material (MDM), and a radiator element all electromagnetically coupled with each other, and defining a combination having: a fractional bandwidth X=dF/F, where dF is a signal bandwidth, and F is a center frequency associated with dF; a volume-to-wavelength ratio Y=V/λ, where V is a volume of the combination, and λ is a wavelength in free space of the signal; and a minimum efficiency defined by Z associated with dF. A first combination has a dimensionless material attribute W associated with operational characteristics of a first MDM, wherein W=Y/(X*Z). A second combination has a dimensionless material attribute W′ associated with operational characteristics of a second MDM having different operational characteristics than the first MDM. The operational characteristics of the second combination satisfy: 0<(W′/W)<(W/W), at a fractional bandwidth X′ equal to or greater than 1.3 MHz/450 MHz and equal to or less than 100 MHz/750 MHz.

### CROSS REFERENCE TO RELATED APPLICATIONS

This application claims the benefit of U.S. Provisional Application Ser. No. 62/611,747, filed Dec. 29, 2017, which is incorporated herein by reference in its entirety.

### BACKGROUND

The present disclosure relates generally to an antenna, and particularly to a magneto-dielectric antenna.

Mobile hand-held devices trend towards increased functionality and/or performance with a reduction in size, resulting in tradeoffs between performance and the available volume for the components responsible for the increased functionality and/or performance. In addition to other challenges, these tradeoffs create a design challenge for the device's antenna, which is typically an Electrically Small Antenna (ESA). Notwithstanding the aforementioned tradeoffs, ESAs are also faced with a fundamental problem of impedance matching. Literature in the art has shown that an ESA could have an effective aperture almost (98%) as high as a half wave dipole antenna, if the antenna has proper impedance matching. To properly match such an antenna matching circuits may be employed, but such matching circuits tend to reduce the antenna efficiency due to insertion losses of the matching components. Other problems associated with ESAs include: an increase in the reactive component of impedance as the antenna volume is decreased, which increases the antenna quality factor, Q-factor, which in turn reduces the antenna bandwidth; and, an increase in resistive losses as the capacitive loading of the antenna elements is reduced by reducing the width of the traces.

Magneto-dielectric structures have the benefit of exploiting shape anisotropy to produce higher ferromagnetic resonance frequencies, and exploiting favorable mix rules for dielectric and magnetic materials to produce a structured arrangement having a low z-axis permittivity and high x-y plane permeability, which is useful for an ESA. However, existing structured arrangements in the form of laminates unfavorably suffer from high magnetic loss, high dielectric loss, and/or low permeability due to a high ratio of dielectric to magnetic material volumes.

While prior publications have disclosed the use of passive, semi passive, or active components to impedance match an ESA, such an ESA will have a dominant reactive component, either capacitive or reactive, which will need to be addressed by the matching circuit, but which in turn will tend to negatively impact the efficiency of the ESA.

Prior publications have also suggested that an ESA may be miniaturized by means of increasing the reactive energy stored in the antenna. However, this additional reactive energy makes the antenna more difficult to match, over any range of bandwidth. A design solution proposed for such a matching problem includes the use of high permeability substrates. However, the use of such substrates has only been demonstrated at low frequencies.

As can be seen, the art of antenna design, particularly ESAs, depends on a balance between competing antenna characteristics, such as for example antenna size, antenna efficiency, antenna Q-factor, antenna bandwidth, antenna operating frequency, and antenna loss elements, which are in turn dependent on the material characteristics used for the antenna.

While existing materials may be suitable for their intended purpose in the art of antennas, the art of antennas would be advanced with a magneto-dielectric material that overcomes at least some of the unfavorable limitations of existing antenna materials, and would be advanced with a design methodology descriptive of how to implement certain magneto-dielectric materials in different antenna designs.

This background information is provided to reveal information believed by the Applicant to be of possible relevance to the present disclosure. No admission is necessarily intended, nor should be construed, that any of the preceding information constitutes prior art against the present disclosure.

### BRIEF SUMMARY

Disclosed herein is an antenna system comprising a magneto-dielectric material and a method of making such a system.

An embodiment includes an antenna system, comprising: a signal feed; a magneto-dielectric material electromagnetically coupled with the signal feed; and a radiator element electromagnetically coupled with the magneto-dielectric material and the signal feed. The signal feed, the magneto-dielectric material, and the radiator element define a combination having: a fractional bandwidth X defined by (dF/F), where dF is a signal bandwidth of the antenna, and F is a center frequency of the signal associated with dF; a volume-to-wavelength ratio Y defined by (V/λ) where V is a volume of the combination, and λ is a wavelength in free space associated with the signal; and an efficiency defined by Z, the efficiency Z being a minimum efficiency associated with dF. A first of the combination has a dimensionless material attribute W associated with operational characteristics of a first of the magneto-dielectric material, wherein W is equal to Y/(X*Z). The first magneto-dielectric material is further defined by operational characteristics corresponding to a set of operable parameters P1, P2, P3 and P4; wherein with respect to operable parameter set P1, V is equal to a defined volume V1, dF is equal to a defined bandwidth dF1, and Z is equal to a defined efficiency Z1, Y is defined by Y1 which is equal to V1/λ, X is defined by X1 which is equal to dF1/F, and W is defined by W1 which is equal to Y1/(X1*Z1); wherein with respect to operable parameter set P2, V is equal to a defined volume V2 that is less than V1, dF is equal to a defined bandwidth dF2 that is less than dF1, Z is equal to a defined efficiency Z2 that is substantially equal to Z1, Y is defined by Y2 which is equal to V2/λ, X is defined by X2 which is equal to dF2/F, and W is defined by W2 which is equal to Y2/(X2*Z2); wherein with respect to operable parameter set P3, V is equal to a defined volume V3 that is less than V2, dF is equal to a defined bandwidth dF3 that is substantially equal to dF2, Z is equal to a defined efficiency Z3 that is less than Z2, Y is defined by Y3 which is equal to V3/λ, X is defined by X3 which is equal to dF3/F, and W is defined by W3 which is equal to Y3/(X3*Z3); and, wherein with respect to operable parameter set P4, V is equal to a defined volume V4 that is greater than V3 and less than V1, dF is equal to a defined bandwidth dF4 that is greater than dF3 and substantially equal to dF1, Z is equal to a defined efficiency Z4 that is substantially equal to Z3, Y is defined by Y4 which is equal to V4/λ, X is defined by X4 which is equal to dF4/F, and W is defined by W4 which is equal to Y4/(X4*Z4). A second of the combination has a dimensionless material attribute W′ associated with operational characteristics of a second of the magneto-dielectric material having different operational characteristics relative to the first magneto-dielectric material. The second magneto-dielectric material is further defined by operational characteristics corresponding to a set of operable parameters P′; wherein with respect to operable parameter set P′, V is defined by V′, dF is defined by dF′, Z is defined by Z′, Y is defined by Y′ which is equal to V′/λ, X is defined by X′ which is equal to dF′/F, and W′ is equal to Y′/(X′*Z′); wherein X′ is equal to or greater than 1.3 MHz/450 MHz and equal to or less than 100 MHz/750 MHz; and, wherein operational characteristics of the second combination associated with the second magneto-dielectric material satisfy the following condition, 0<(W′/W)<(W/W).

An embodiment includes an Internet of Things (IoT) type device comprising one or more of the aforementioned antenna system.

An embodiment includes an antenna array system, comprising: a plurality of the aforementioned antenna system, each antenna system of the plurality being disposed within a unit area defined by equal to or less than λ/4×λ/4.

An embodiment includes a method of designing an antenna system having a signal feed, a magneto-dielectric electromagnetically coupled with the signal feed, and a radiator element electromagnetically coupled with the magneto-dielectric material and the signal feed, wherein the signal feed, the magneto-dielectric material, and the radiator element define a combination, the method comprising: defining a fractional bandwidth X being equal to (dF/F), where dF is a signal bandwidth of the antenna, and F is a center frequency of the signal associated with dF; defining a volume-to-wavelength ratio Y being equal to (V/λ) where V is a volume of the combination, and λ is a wavelength in free space associated with the signal; defining an efficiency Z, where the efficiency Z is a minimum efficiency associated with dF; defining a dimensionless material attribute W associated with operational characteristics of a first of the magneto-dielectric material associated with a first of the combination, where W is equal to Y/(X*Z). Further defining the first magneto-dielectric material by operational characteristics corresponding to a set of operable parameters P1, P2, P3 and P4; wherein with respect to operable parameter set P1, V is equal to a defined volume V1, dF is equal to a defined bandwidth dF1, and Z is equal to a defined efficiency Z1, Y is defined by Y1 which is equal to V1/λ, X is defined by X1 which is equal to dF1/F, and W is defined by W1 which is equal to Y1/(X1*Z1); wherein with respect to operable parameter set P2, V is equal to a defined volume V2 that is less than V1, dF is equal to a defined bandwidth dF2 that is less than dF1, Z is equal to a defined efficiency Z2 that is substantially equal to Z1, Y is defined by Y2 which is equal to V2/λ, X is defined by X2 which is equal to dF2/F, and W is defined by W2 which is equal to Y2/(X2*Z2); wherein with respect to operable parameter set P3, V is equal to a defined volume V3 that is less than V2, dF is equal to a defined bandwidth dF3 that is substantially equal to dF2, Z is equal to a defined efficiency Z3 that is less than Z2, Y is defined by Y3 which is equal to V3/λ, X is defined by X3 which is equal to dF3/F, and W is defined by W3 which is equal to Y3/(X3*Z3); wherein with respect to operable parameter set P4, V is equal to a defined volume V4 that is greater than V3 and less than V1, dF is equal to a defined bandwidth dF4 that is greater than dF3 and substantially equal to dF1, Z is equal to a defined efficiency Z4 that is substantially equal to Z3, Y is defined by Y4 which is equal to V4/λ, X is defined by X4 which is equal to dF4/F, and W is defined by W4 which is equal to Y4/(X4*Z4). Defining a dimensionless material attribute W′ associated with operational characteristics of a second of the magneto-dielectric material associated with a second of the combination, the second magneto-dielectric material having different operational characteristics relative to the first magneto-dielectric material. Further defining the second magneto-dielectric material by operational characteristics corresponding to a set of operable parameters P′; wherein with respect to operable parameter set P′, V is defined by V′, dF is defined by dF′, Z is defined by Z′, Y is defined by Y′ which is equal to V′/λ, X is defined by X′ which is equal to dF′/F, and W′ is equal to Y′/(X′*Z′); wherein X′ is equal to or greater than 1.3 MHz/450 MHz and equal to or less than 100 MHz/750 MHz; and, wherein operational characteristics of the second combination associated with the second magneto-dielectric material satisfy the following condition, 0<(W′/W)<(W/W).

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 depicts a rotated perspective view of an example antenna system, in accordance with an embodiment;

FIG. 2 depicts a rotated perspective view of an array of the antenna system of FIG. 1, in accordance with an embodiment;

FIG. 3 depicts a schematic of an equivalent electrical circuit model of the antenna system of FIG. 1 as a set of lumped parameters, in accordance with an embodiment;

FIG. 4 depicts a schematic or symbolic representation of a plurality of the antenna system of FIG. 1 having respective sets of operable parameters, in accordance with an embodiment, and a method for modifying the operable parameters to change from one antenna system to another, in accordance with an embodiment;

FIG. 5 depicts a visual illustration of how a dimensionless material attribute W′ associated with operational characteristics of a second magneto-dielectric material in accordance with an embodiment, differs from a dimensionless material attribute W associated with operational characteristics of a first magneto-dielectric material that is known in the art, in accordance with an embodiment;

FIGS. 6, 6A, 6B, 6C, and 6D, depict a combination of and individual ones of a variety of the antenna system of FIG. 1 that may be suitable for an antenna system in accordance with an embodiment; and

FIG. 7 depicts a method for providing an antenna system of FIG. 1, in accordance with an embodiment.

### DETAILED DESCRIPTION

Although the following detailed description contains many specifics for the purpose of illustration, anyone of ordinary skill in the art will appreciate that many variations and alterations to the following details are within the scope of the invention. Accordingly, the following example embodiments are set forth without any loss of generality to, and without imposing limitations upon, the claimed invention.

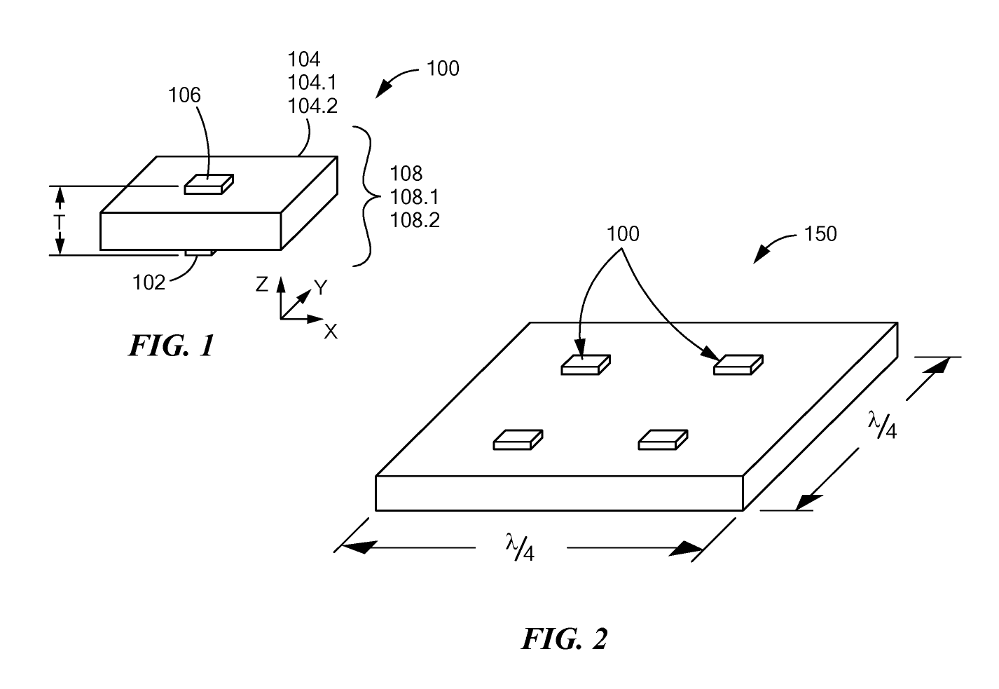

In an embodiment, and with reference to FIG. 1, an example antenna system 100 (herein also referred to as an ESA) includes a signal feed 102, a magneto-dielectric material 104 electromagnetically coupled with the signal feed 102, and a radiator element 106 electromagnetically coupled with the magneto-dielectric material 104 and the signal feed 102. In an embodiment, the signal feed 102 may be any one of: first and second spring connections, wherein the first spring connection is a signal connection and the second spring connection is a ground connection; a coaxial cable having a centrally disposed signal line, a dielectric surrounding the signal line, and a ground line disposed outboard of the dielectric; a printed circuit board signal trace; a capacitive coupling; or, a magnet coupling. In an embodiment, the signal feed in the form of the printed circuit board signal trace may include one of: a micro-strip; a substrate integrated waveguide; or, a coplanar waveguide. The signal feed 102, the magneto-dielectric material 104, and the radiator element 106 define a combination 108 having materially defined operational characteristics, which will be discussed in more detail below. In general and as applied herein, the combination 108 has an overall thickness T in the z-direction, and has dimensions in the x and y directions that are normalized to unity so that T as used herein is also representative of the volume V of the combination 108. Also, while FIG. 1 depicts the signal feed 102 and the radiator element 106 structurally extending proud of an outer surface of the magneto-dielectric material 104, it will be appreciated that this is for illustration purposes only, and that a scope of an invention disclosed herein is not so limited and encompasses other structural arrangements, such as, for example, one or both of the signal feed 102 and the radiator element 106 being integrally arranged with, and not extending proud of, the magneto-dielectric material 104. Any and all such combinations 108 that fall with the ambit of the claims appended hereto are considered to be within the scope of an invention disclosed herein.

While the signal feed 102 is depicted in FIG. 1 having a block-like structure, it will be appreciated that this is for illustration purposes only, and that the actual structure of an example signal feed 102 as herein disclosed may have any structure suitable for a purpose disclosed herein, such as for example but not limited to: a microstrip (e.g., with slotted aperture); a coaxial cable; a copper wire; a stripline (e.g., with slotted aperture); a waveguide; a surface integrated waveguide; a conductive ink, spring pin (e.g., Pogo pin), for example; or, any combination of the foregoing. While the magneto-dielectric material 104 is depicted in FIG. 1 having a block-like structure, it will be appreciated that this is for illustration purposes only, and that the actual structure of an example magneto-dielectric material 104 as herein disclosed may have any structure suitable for a purpose disclosed herein, such as for example but not limited to: a single material; a mixture of two or more constituents; a structured dispersion of two or more constituents; or, any combination of the foregoing. While the radiator element 106 is depicted in FIG. 1 having a block-like structure, it will be appreciated that this is for illustration purposes only, and that the actual structure of an example radiator element 106 as herein disclosed may have any structure suitable for a purpose disclosed herein, such as for example but not limited to: a patch antenna; an inverted-F antenna (IFA); a planar IFA (PIFA); a meanderline IFA; a monopole antenna; a folded monopole antenna; a dipole antenna; a folded dipole antenna; or, any combination of the foregoing.

FIG. 2 depicts an antenna array system 150 having a plurality of antenna systems 100, where each antenna system 100 of the plurality are disposed within a unit area defined by equal to or less than λ/4×λ/4. In an embodiment of the antenna array system 150, λ is the free space wavelength of an operating frequency at 450 MHz. In an embodiment, the antenna array system 150 includes a number of the antenna designs 100 as disclosed further herein below that is equal to or greater four and equal to or less than eight. In an embodiment of the antenna array system 150, polarization diversity methods are utilized to improve the isolation and envelope correlation coefficient between least spatially separated neighboring antenna elements, as compared to a like antenna array system absent such polarization diversity. In an embodiment, the envelope correlation coefficient between two most correlated elements is between 0.05 and 0.5. In an embodiment, the envelope correlation coefficient between two least correlated elements is between 0.01 and 0.3.

Operational parameters associated with an antenna system 100 may be defined as follows: a fractional bandwidth X as defined by (dF/F), where dF is a signal bandwidth of the antenna, and F is a center frequency of the signal associated with dF, where F is defined as the point of minimum return loss S11 within a desired frequency range, such as from 400 MHz to 1 GHz, and dF is defined as the signal bandwidth about the center frequency F where the return loss S11 is equal to −6 dBi; a volume-to-wavelength ratio Y as defined by (V/λ) where V is a volume of the antenna and λ is a wavelength in free space associated with the signal; and an efficiency defined by Z, the efficiency Z being a minimum efficiency associated with dF. In an example embodiment, the return loss S11 was measured using a vector network analyzer.

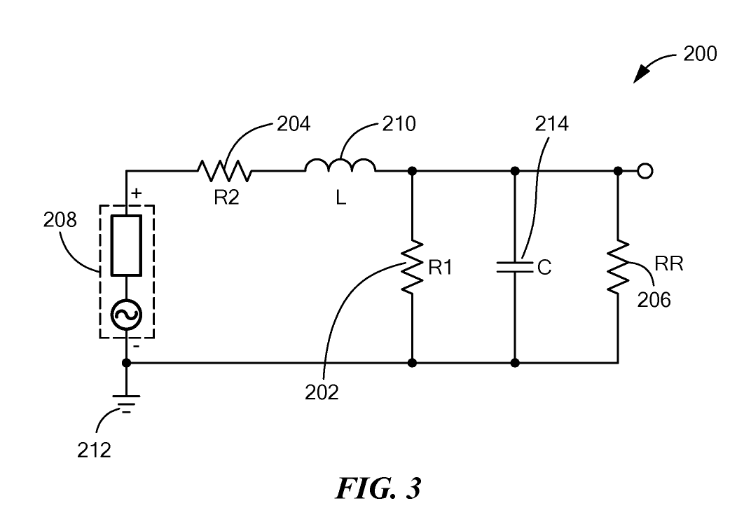

When an antenna system 100, more particularly an ESA, is viewed as a set of lumped parameters (see FIG. 3, for example, discussed further below), it will be appreciated that the substrate of the antenna can influence the resonant frequency of the antenna through the two parameters of inductance (L) and capacitance (C), where the inductance is proportional to the permeability of the substrate material and proportional to the thickness of the substrate material, and where the capacitance is proportional to the dielectric constant (Dk) of the substrate material and inversely proportional to the thickness of the substrate material. In comparison, the intrinsic impedance of a given material is equal to, sqrt(relative permeability/relative permittivity), for the given material, and is frequency dependent. The Q-factor of the antenna is a function of three resistances: a first lossy resistance (R1) that is related to the resistivity of the substrate material (may be modeled as infinite for most substrate materials); a second lossy resistance (R2) that is related to the substrate material and metallic losses in the antenna; and, a radiation resistance (RR) that is desirable energy loss due to the electromagnetic radiation from the antenna. The radiation efficiency of the antenna is equal to RR/(RR+R1+R2), and the Q-factor of the antenna is equal to the ratio of (ω)(Preact)/(Prad), where ω is the angular frequency of an associated propagating wave, Preact is the reactive power of the antenna, and Prad is the radiated power of the antenna.

FIG. 3 depicts an equivalent electrical circuit model 200 of an ESA 100 as a set of lumped parameters having the above mentioned resistances R1 202, R2 204, and RR 206. In the model 200, a power input 208 is provided to a matching impedance of 50 Ohm with input to R2 204. In series with R2 204 is the inductor L 210 having an output directly connected to the high voltage terminal of the RR 206. The low voltage terminal of RR 206 is connected to ground 212, and R1 202 and the capacitor C 214 are connected in parallel between the high voltage terminal of RR 206 and ground 212.

By evaluating an ESA 100 by it equivalent electrical circuit model 200, the following will be appreciated: (1) the ratio of capacitance to inductance, influenced by substrate permeability and permittivity, has little to no effect on the bandwidth of the antenna; (2) the bandwidth of the antenna will be a function of reactive impedance to losses, due to radiation and substrate/metallic losses; and, (3) reducing the reactance of the antenna will shift the resonant frequency of the antenna.

For an embodiment of the invention as disclosed herein, an antenna system and design methodology for achieving such an antenna system provides an antenna system with an increase of the radiated power of the antenna for a given volume of the antenna, as compared to an existing antenna of similar volume but lower radiated power, or as compared to an existing antenna of similar radiated power but greater volume. As such, as desired end state for an antenna as disclosed herein is an antenna having a best performance for a given volume, as opposed to simply a smallest possible antenna.

As described in connection with FIG. 1, an embodiment provides an antenna system 100 having magneto-dielectric material 104 electromagnetically coupled to a signal feed 102 and a radiator element 106 that collectively define a combination 108, wherein a first of the combination 108.1 has a dimensionless material attribute W associated with operational characteristics of a first magneto-dielectric material 104.1, wherein a second of the combination 108.2 has a dimensionless material attribute W′ associated with operational characteristics of a second magneto-dielectric material 104.2 having different operational characteristics relative to the first magneto-dielectric material 104.1, and wherein the operational characteristics of the second combination 108.2 associated with the second magneto-dielectric material 104.2 satisfy the following condition, 0<(W′/W)<(W/W), where the first magneto-dielectric material 104.1 and its associated dimensionless material attribute W relate to a magneto-dielectric material known in the art, and where the second magneto-dielectric material 104.2 and its associated dimensionless material attribute W′ relate to a magneto-dielectric material as herein disclosed, which is discussed in more detail below.

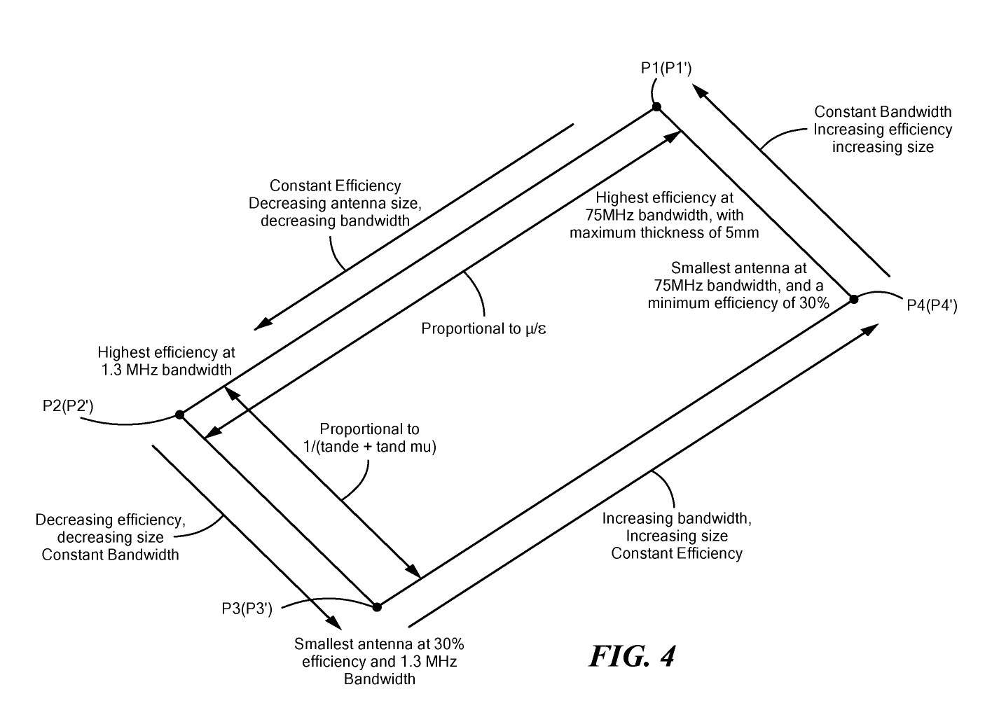

The dimensionless material attribute W associated with the operational characteristics of the first magneto-dielectric material 104.1 is defined as; W is equal to Y/(X*Z), where X is the aforementioned fractional bandwidth, Y is the aforementioned volume-to-wavelength ratio, and Z is the aforementioned efficiency, of the associated antenna 100. The first magneto-dielectric material 104.1 is further defined by operational characteristics corresponding to a set of operable parameters P1, P2, P3 and P4, which will now be discussed with reference to FIG. 4.

FIG. 4 depicts a schematic or symbolic representation of a plurality of antenna designs having respective sets of operable parameters denoted by P1, P2, P3 and P4 (P1′, P2′, P3′ and P4′ are also denoted, which will be discussed further below), and also depicts a process for modifying the operable parameters to change from one antenna design to another, such as shifting from antenna design at P1 to antenna design at P2, from antenna design at P2 to antenna design at P3, from antenna design at P3 to antenna design at P4, and from antenna design at P4 back to antenna design at P1. As used herein, the set of operable parameters denoted by P# may be interchangeably referred to as an antenna design, operable parameters of an antenna, or as an operable parameter set.

With respect to operable parameter set P1 as depicted in FIG. 4, V is equal to a defined volume V1, dF is equal to a defined bandwidth dF1, Z is equal to a defined efficiency Z1, Y is defined by Y1 which is equal to V1/λ, X is defined by X1 which is equal to dF1/F, and W is defined by W1 which is equal to Y1/(X1*Z1). Furthermore, V1 is equal to a maximum volume relative to P2, P3 and P4; dF1 is equal to a maximum bandwidth relative to P2, P3 and P4, and Z1 is equal to a maximum efficiency relative to P2, P3 and P4.

With respect to operable parameter set P2 as depicted in FIG. 3, V is equal to a defined volume V2 that is less than V1, dF is equal to a defined bandwidth dF2 that is less than dF1, Z is equal to a defined efficiency Z2 that is substantially equal to Z1, Y is defined by Y2 which is equal to V2/λ, X is defined by X2 which is equal to dF2/F, and W is defined by W2 which is equal to Y2/(X2*Z2). Furthermore, with V2<V1, dF2<dF1, and Z2=Z1, it will be appreciated that an antenna design at P2 will have a smaller size, a decreased bandwidth, and substantially the same efficiency, as an antenna design at P1.

With respect to operable parameter set P3 as depicted in FIG. 3, V is equal to a defined volume V3 that is less than V2, dF is equal to a defined bandwidth dF3 that is substantially equal to dF2, Z is equal to a defined efficiency Z3 that is less than Z2, Y is defined by Y3 which is equal to V3/λ, X is defined by X3 which is equal to dF3/F, and W is defined by W3 which is equal to Y3/(X3*Z3). Furthermore, with V3<V2, dF3=dF2, and Z3<Z2, it will be appreciated that an antenna design at P3 will have a smaller size, substantially the same bandwidth, and a decreased efficiency, as an antenna design at P2.

With respect to operable parameter set P4 as depicted in FIG. 3, V is equal to a defined volume V4 that is greater than V3 and less than V1, dF is equal to a defined bandwidth dF4 that is greater than dF3 and substantially equal to dF1, Z is equal to Z4 that is substantially equal to Z3, Y is defined by Y4 which is equal to V4/λ, X is defined by X4 which is equal to dF4/F, and W is defined by W4 which is equal to Y4/(X4*Z4). Furthermore, with V4>V3, dF3<dF4=dF1, and Z4=Z3, it will be appreciated that an antenna design at P4 will have a larger size, an increased bandwidth, and substantially the same efficiency, as an antenna at P3. Also, with dF4=dF1, the antenna design at P4 will have substantially the same bandwidth as an antenna at P1. Furthermore, with V4<V1, the antenna design at P4 will have a smaller size at the same bandwidth, but with lower efficiency that an antenna at P1.

By comparing the operable parameters sets of P1, P2, P3 and P4, relative to each other, it can be seen than an antenna design at P1 will have a maximum efficiency, at a maximum bandwidth, but at a maximum volume, as compared to antenna designs at P2, P3 and P4. It can also be seen that an antenna design at P3 will have a minimum efficiency, at a minimum bandwidth, but at a minimum volume, as compared to antenna designs at P1, P2 and P4. It can also be seen that antenna designs at P1 and P2 have substantially the same efficiency, that antenna designs at P3 and P4 have substantially the same efficiency, that antenna designs at P2 and P3 have substantially the same bandwidth, and that antenna designs at P4 and P1 have substantially the same bandwidth.

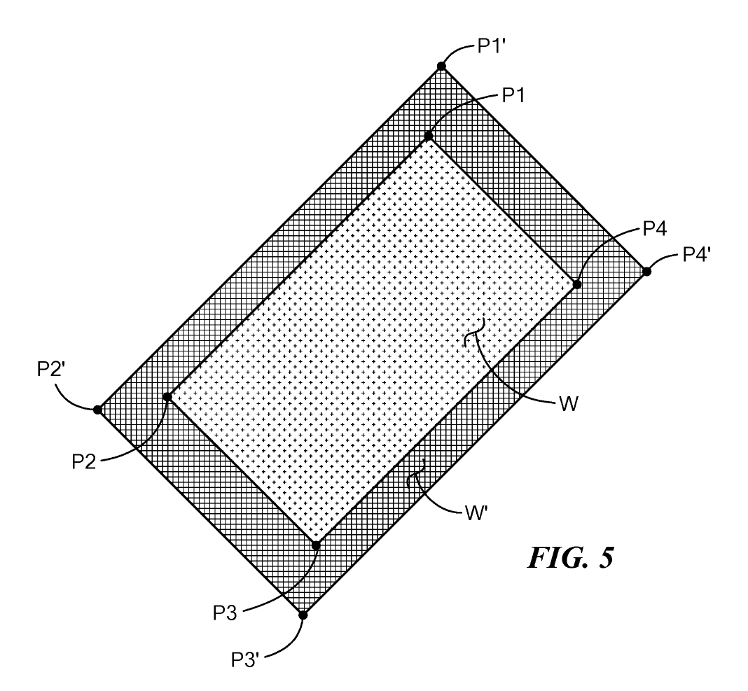

The foregoing description of antenna designs at P1, P2, P3 and P4, have been made with reference to the first magneto-dielectric material 104.1. With reference now to FIG. 5 in combination with FIG. 4, reference will now be made to antenna designs at P1′, P2′, P3′ and P4′, which are made with reference to the second magneto-dielectric material 104.2, which is different from the first magneto-dielectric material 104.1. While not all of the text detail of FIG. 4 is duplicated in FIG. 5 for clarity purposes, it will be appreciated that FIG. 4 may be mapped onto FIG. 5 by overlaying the antenna designs at P1, P2, P3 and P4 from FIG. 4 to FIG. 5. With such mapping, it will be appreciated that the antenna design at P1′ is associated with the antenna design at P1, that the antenna design at P2′ is associated with the antenna design at P2, that the antenna design at P3′ is associated with the antenna design at P3, and that the antenna design at P4′ is associated with the antenna design at P4. It will be further appreciated that with such mapping the dimensionless material attribute W associated with the operational characteristics of the first magneto-dielectric material 104.1 is depicted by the speckled region that is denoted by W.

First, and as noted herein above, the second of the combination 108.2 has a dimensionless material attribute W′ associated with operational characteristics of the second magneto-dielectric material 104.2 having different operational characteristics relative to the first magneto-dielectric material 104.1, and wherein the operational characteristics of the second combination 108.2 associated with the second magneto-dielectric material 104.2 satisfy the following condition, 0<(W′/W)<(W/W). In an embodiment, W′/W is equal to or less than 0.66. The dimensionless material attribute W associated with the operational characteristics of the first magneto-dielectric material 104.1 was described herein above. The dimensionless material attribute W′ associated with the operation characteristics of the second magneto-dielectric material 104.2 will now be described herein below.

In general, the second magneto-dielectric material is defined by operational characteristics corresponding to a set of operable parameters P′ (with specific reference being made to operable parameter sets or antenna designs P1′, P2′, P3′ and P4′), where with respect to the operable parameter set P′, V is defined by V′, dF is defined by dF′, Z is defined by Z′, Y is defined by Y′ which is equal to V′/λ, X is defined by X′ which is equal to dF′/F, and W′ is equal to Y′/(X′*Z′).

Associated with antenna design at P1 having the first magneto-dielectric material 104.1, herein disclosed is an antenna design at P1′ having the second magneto-dielectric material 104.2. With respect to the associated operable parameter set P1, P′ is defined by P1′, V′ is defined by V1′, dF′ is defined by dF1′, Z′ is defined by Z1′, Y′ is defined by Y1′ which is equal to V1′/λ, X′ is defined by X1′ which is equal to dF1′/F, and W′ is defined by W1′ which is equal to Y1′/(X1′*Z1′). In embodiment, W1′ is less than W1. In an embodiment, W1′/W1 is equal to or less than 0.66.

Similarly, associated with antenna design at P2 having the first magneto-dielectric material 104.1, herein disclosed is an antenna design at P2′ having the second magneto-dielectric material 104.2. With respect to associated operable parameter set P2, P′ is defined by P2′, V′ is defined by V2′ that is less than V1′, dF′ is defined by dF2′ that is less than dF1′, Z′ is defined by Z2′ that is substantially equal to Z1′, Y′ is defined by Y2′ which is equal to V2′/λ, X′ is defined by X2′ which is equal to dF2′/F, and W′ is defined by W2′ which is equal to Y2′/(X2′*Z2′). In embodiment, W2′ is less than W2. In an embodiment, W2′/W2 is equal to or less than 0.66.

Similarly, associated with antenna design at P3 having the first magneto-dielectric material 104.1, herein disclosed is an antenna design at P3′ having the second magneto-dielectric material 104.2. With respect to associated operable parameter set P3, P′ is defined by P3′, V′ is defined by V3′ that is less than V2′, dF′ is defined by dF3′ that is substantially equal to dF2′, Z′ is defined by Z3′ that is less than Z2′, Y′ is defined by Y3′ which is equal to V3′/λ, X′ is defined by X3′ which is equal to dF3′/F, and W′ is defined by W3′ which is equal to Y3′/(X3′*Z3′). In embodiment, W3′ is less than W3. In an embodiment, W3′/W3 is equal to or less than 0.66.

Similarly, associated with antenna design at P4 having the first magneto-dielectric material 104.1, herein disclosed is an antenna design at P4′ having the second magneto-dielectric material 104.2. With respect to associated operable parameter set P4, P′ is defined by P4′, V′ is defined by V4′ that is greater than V3′ and less than V1′, dF′ is defined by dF4′ that is greater than dF3′ and substantially equal to dF1′, Z′ is defined by Z4′ that is substantially equal to Z3′, Y′ is defined by Y4′ which is equal to V4′/λ, X′ is defined by X4′ which is equal to dF4′/F, and W′ is defined by W4′ which is equal to Y4′/(X4′*Z4′). In embodiment, W4′ is less than W4. In an embodiment, W4′/W4 is equal to or less than 0.66.

With the above noted mapping of FIG. 4 onto FIG. 5, it will be further appreciated that with such mapping the dimensionless material attribute W′ associated with the operational characteristics of the second magneto-dielectric material 104.2 is depicted by the cross-hatched region that is denoted by W′. FIG. 5 therefore provides a visual illustration of how the dimensionless material attribute W′ associated with the operational characteristics of the second magneto-dielectric material 104.2 disclosed herein, differs from the dimensionless material attribute W associated with the operational characteristics of the first magneto-dielectric material 104.1 that is known in the art.

In an embodiment: dF, dF′, or both dF and dF′, are equal to or greater than 1.3 MHz and equal to or less than 100 MHZ; F is equal to or greater than 450 MHz and equal to or less than 750 MHz; and, X, X′, or both X and X′, are equal to or greater than 1.3 MHz/450 MHz and equal to or less than 100 MHz/750 MHz. In an embodiment, dF, dF′, or both dF and dF′, are equal to or less than 75 MHz. In an embodiment, dF1, dF1′, or both dF1 and dF1′, are equal to around 75 MHz. In an embodiment, dF2, dF2′, or both dF2 and dF2′, are equal to around 1.3 MHz.

In an embodiment, V1 has a thickness dimension T1 that is equal to around 5 millimeters (mm), dF1 is equal to or less than around 100 MHz, and Z1 is greater than or equal to 25% and less than or equal to 90%. In an embodiment, V3 has a thickness dimension T3 that is equal to or greater than 1 mm, and Z3 is equal to around 25%.

In an embodiment, V1′ has a thickness dimension T1′ that is equal to around 5 millimeters (mm), dF1′ is equal to or less than around 100 MHz, and Z1′ is greater than or equal to 25% and less than or equal to 90%. In an embodiment, V3′ has a thickness dimension T3′ that is equal to or greater than 1 mm and Z3′ is equal to around 25%.

In an embodiment, the first magneto-dielectric material 104.1 of the first combination 108.1 has a permeability μ and a permittivity E, and an operational characteristic between antenna design at P1 and antenna design at P2 that is proportional to the ratio of WE.

In an embodiment, the second magneto-dielectric material 104.2 of the second combination 108.2 has a permeability λ and a permittivity E, and an operational characteristic between antenna design at P1′ and antenna design at P2′ that is proportional to the ratio of μ/ε.

The magneto-dielectric materials 104.1, 104.2 (collectively referred to by reference numeral 104) have, respectively, an overall electric loss tangent (tan δₑ), an overall magnetic loss tangent (tan δₘ), and an overall quality factor (Q) defined by (1/((tan δₑ)+(tan δₘ). The overall quality factor Q can be determined according to a standardized Nicolson-Roth-Weir (NRW) method, see NIST (National Institute of Standards and Technology) Technical Note 1536, “Measuring the Permittivity and Permeability of Lossy Materials: Solids, Liquids, Metals, Building Materials, and Negative-Index Materials”, James Baker Jarvis et. al., February 2005, CODEN: NTNOEF, pp 66-74, for example. The NRW method provides calculations for E′ and E″ (complex relative permittivity components), and for μ′ and μ″ (complex relative permeability components). The loss tangents μ″/μ′ (tan δₘ) and ε″/ε′ (tank) can be calculated from those results. The quality factor Q is the inverse of the sum of the loss tangents.

In an embodiment, the first magneto-dielectric material 104.1 of the first combination 108.1 has an electrical loss tangent (tan δₑ) and a magnetic loss tangent (tan δₘ), and an operational characteristic between antenna design at P2 and antenna design P3 that is proportional to 1/((tan δₑ)+(tan δₘ).

In an embodiment, the second magneto-dielectric material 104.2 of the second combination 108.2 has an electrical loss tangent (tan δₑ) and a magnetic loss tangent (tan δₘ), and an operational characteristic between antenna design at P2′ and antenna design P3′ that is proportional to 1/((tan δₑ)+(tan δₘ).

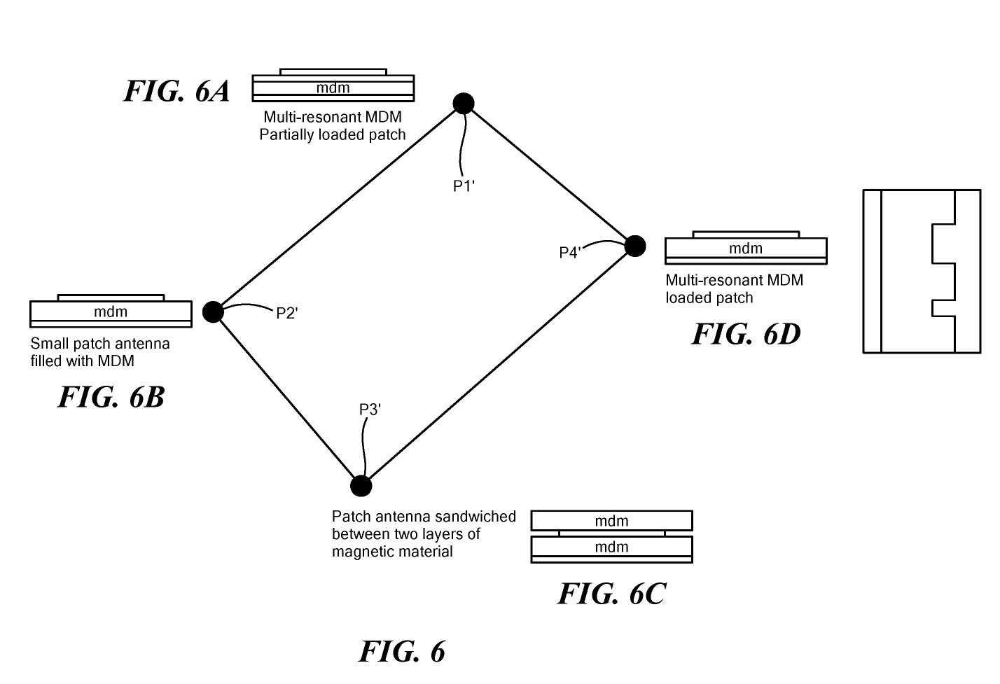

With reference now to FIGS. 6, 6A, 6B, 6C and 6D, a variety of antenna systems 100 may be suitable for an antenna design P′ (separately denoted as P1′, P2′, P3′ and P4′) as disclosed herein. For example, an antenna design at P1′ may have a double dipole type resonator, and/or may have a multi-resonant magneto-dielectric material with a partially loaded patch, as depicted in FIG. 6A. An antenna design at P2′ may have a radiator element that is a patch type resonator, and/or may be a small patch antenna that is filled with magneto-dielectric material, as depicted in FIG. 6B. An antenna design at P3′ may have a radiator element that is a planar inverted F-type resonator, and/or may be a patch antenna that is sandwiched between two layers of a magneto-dielectric material to provide multiple resonant modes, as depicted in FIG. 6C. An antenna design at P4′ may have a radiator element that is a dipole type resonator, and/or may have a multi-resonant magneto-dielectric material with a fully loaded patch, as depicted in FIG. 6D.

In an embodiment, a plurality of any of the antenna designs at P1′, P2′, P3′ or P4′, as disclosed herein, may be incorporated into the antenna array system 150 (see FIG. 2 for example), and any one or more of the antenna designs at P1′, P2′, P3′ or P4′, or arrays thereof, may be incorporated into an Internet of Things (IoT).

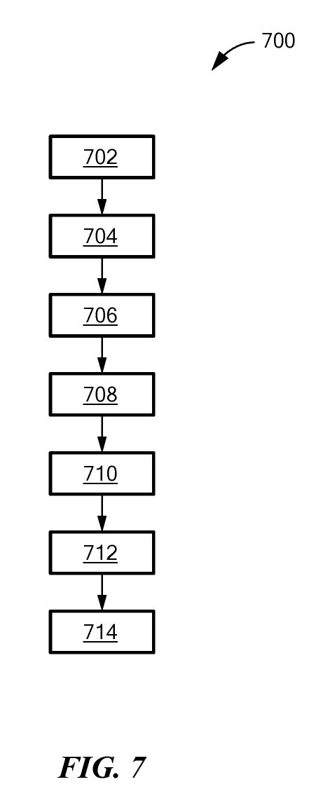

In view of all of the foregoing, it will be appreciated that an embodiment of the invention also includes a method of providing an antenna system 100 according to any one of the antenna designs at P1′, P2′, P3′ or P4′. In an embodiment, and with reference to FIG. 7, the method 700 includes:
defining 702 a fractional bandwidth X being equal to (dF/F), where dF is a signal bandwidth of the antenna, and F is a center frequency of the signal associated with dF;
defining 704 a volume-to-wavelength ratio Y being equal to (V/λ) where V is a volume of the combination and λ is a wavelength in free space associated with the signal;
defining 706 an efficiency Z, where the efficiency Z is a minimum efficiency associated with dF;
defining 708 a dimensionless material attribute W associated with operational characteristics of a first magneto-dielectric material associated with a first of the combination, where W is equal to Y/(X*Z);
defining 710 the first magneto-dielectric material by operational characteristics corresponding to a set of operable parameters P1, P2, P3 and P4;
wherein with respect to operable parameter set P1, V is equal to a defined volume V1, dF is equal to a defined bandwidth dF1, and Z is equal to a defined efficiency Z1, Y is defined by Y1 which is equal to V1/λ, X is defined by X1 which is equal to dF1/F, and W is defined by W1 which is equal to Y1/(X1*Z1);
wherein with respect to operable parameter set P2, V is equal to a defined volume V2 that is less than V1, dF is equal to a defined bandwidth dF2 that is less than dF1, Z is equal to a defined efficiency Z2 that is substantially equal to Z1, Y is defined by Y2 which is equal to V2/λ, X is defined by X2 which is equal to dF2/F, and W is defined by W2 which is equal to Y2/(X2*Z2);
wherein with respect to operable parameter set P3, V is equal to a defined volume V3 that is less than V2, dF is equal to a defined bandwidth dF3 that is substantially equal to dF2, Z is equal to a defined efficiency Z3 that is less than Z2, Y is defined by Y3 which is equal to V3/λ, X is defined by X3 which is equal to dF3/F, and W is defined by W3 which is equal to Y3/(X3*Z3);
wherein with respect to operable parameter set P4, V is equal to a defined volume V4 that is greater than V3 and less than V1, dF is equal to a defined bandwidth dF4 that is greater than dF3 and substantially equal to dF1, Z is equal to a defined efficiency Z4 that is substantially equal to Z3, Y is defined by Y4 which is equal to V4/λ, X is defined by X4 which is equal to dF4/F, and W is defined by W4 which is equal to Y4/(X4*Z4);
defining 712 a dimensionless material attribute W′ associated with operational characteristics of a second magneto-dielectric material associated with a second of the combination, the second magneto-dielectric material having different operational characteristics relative to the first magneto-dielectric material;
defining 714 the second magneto-dielectric material by operational characteristics corresponding to a set of operable parameters P′;
wherein with respect to operable parameter set P′, V is defined by V′, dF is defined by dF′, Z is defined by Z′, Y is defined by Y′ which is equal to V′/λ, X is defined by X′ which is equal to dF′/F, and W′ is equal to Y′/(X′*Z′);
wherein X′ is equal to or greater than 1.3 MHz/450 MHz and equal to or less than 100 MHz/750 MHz, and
wherein operational characteristics of the second combination associated with the second magneto-dielectric material satisfy the following condition, 0<(W′/W)<(W/W).

In an embodiment, the method 700 further includes:
with respect to associated operable parameter set P1, P′ is defined by P1′, V′ is defined by V1′, dF′ is defined by dF1′, Z′ is defined by Z1′, Y′ is defined by Y1′ which is equal to V1′/λ, X′ is defined by X1′ which is equal to dF1′/F, and W′ is defined by W1′ which is equal to Y1′/(X1′*Z1′); and W1′ is less than W1; with respect to associated operable parameter set P2, P′ is defined by P2′, V′ is defined by V2′ that is less than V1′, dF′ is defined by dF2′ that is less than dF1′, Z′ is defined by Z2′ that is substantially equal to Z1′, Y′ is defined by Y2′ which is equal to V2′/λ, X′ is defined by X2′ which is equal to dF2′/F, W′ is defined by W2′ which is equal to Y2′/(X2′*Z2′), and W2′ is less than W2;
with respect to associated operable parameter set P3, P′ is defined by P3′, V′ is defined by V3′ that is less than V2′, dF′ is defined by dF3′ that is substantially equal to dF2′, Z′ is defined by Z3′ that is less than Z2′, Y′ is defined by Y3′ which is equal to V3′/λ, X′ is defined by X3′ which is equal to dF3′/F, W′ is defined by W3′ which is equal to Y3′/(X3′*Z3′), and W3′ is less than W3; and
with respect to associated operable parameter set P4, P′ is defined by P4′, V′ is defined by V4′ that is greater than V3′ and less than V1′, dF′ is defined by dF4′ that is greater than dF3′ and substantially equal to dF1′, Z′ is defined by Z4′ that is substantially equal to Z3′, Y′ is defined by Y4′ which is equal to V4′/λ, X′ is defined by X4′ which is equal to dF4′/F, W′ is defined by W4′ which is equal to Y4′/(X4′*Z4′), and W4′ is less than W4.

In an embodiment, the method 700 further includes:
wherein W1′/W1 is equal to or less than 0.66;
wherein W2′/W2 is equal to or less than 0.66;
wherein W3′/W3 is equal to or less than 0.66; and
wherein W4′/W4 is equal to or less than 0.66.

Taking into consideration all of the foregoing, it will be appreciated that the dimensionless material attribute W associated with operational characteristics of the first magneto-dielectric material 104.1, which has operational characteristics corresponding to the set of operable parameters P1, P2, P3 and P4, relate to known magneto-dielectric materials that may be utilized for an antenna system having the ability to produce a given radiated Power (Prad) for a given antenna volume (V). It will also be appreciated that the dimensionless W′ associated with operational characteristics of the second magneto-dielectric material 104.2, which has operational characteristics corresponding to the set of associated operable parameters P1′, P2′, P3′ and P4′, relate to inventive magneto-dielectric materials as disclosed herein that may be utilized for an antenna system having the ability to produce an improved radiated Power (Prad′) for a given antenna volume (V′), where Prad′/V′ is greater than Prad/V. The inventive aspects of the second magneto-dielectric material 104.2, where Prad′/V′ is greater than Prad/V, is herein described as follows: W′ is less than W; W1′ is less than W1; W2′ is less than W2; W3′ is less than W3; W4′ is less than W4; W1′/W1 is equal to or less than 0.66; W2′/W2 is equal to or less than 0.66; W3′/W3 is equal to or less than 0.66; and/or, W4′/W4 is equal to or less than 0.66.

An example embodiment of an inventive second magneto-dielectric material 104.2 as disclosed herein having operational characteristics associated with the dimensionless material attribute W′, versus a known first magneto-dielectric material 104.1 having operational characteristics associated with the dimensionless material attribute W, can be seen with reference to the following Table-1, which provides empirical test results associated with two modeled antennas, both being folded monopole antennas; a first antenna using an example of the first magneto-dielectric material 104.1 having a set of operable parameters P and a resulting dimensionless material attribute W normalized with respect to itself to 1; and, a second antenna of like construction to the first antenna, but using an example of the second magneto-dielectric material 104.2 as disclosed herein having a set of operable parameters P′ and a resulting dimensionless material attribute W′ normalized with respect to W.

TABLE 1

| Max eff @ | | | | | | | | | W, W′ |
|---|---|---|---|---|---|---|---|---|---|
| 753 MHz | | | F | dF, dF′ | V, V′ | RadEff | Z, Z′ | | Normalized |
| 100 MHz BW | f1 | f2 | F | BW | L | @ 753 MHz | MinEff | | (basis of |
| (−6 dBi) | (MHz) | (MHz) | (MHz) | (%) | (mm) | (%) | (%) | FOM | Sample P) |
| Sample-P | 715 | 783 | 749 | 9.08 | 93.83 | 96.35 | 72.33 | 14.289 | 1.000 |
| Sample-P′ | 709 | 792 | 751 | 11.06 | 68.53 | 90.88 | 67.1 | 9.235 | 0.646 |

Material characteristics for the embodiments of Sample-P and Sample-P′ of Table-1 are provided in Table-2 below.

TABLE 2

| Material | | | | tandmu | tandmu @ | tandmu | tandmu |
|---|---|---|---|---|---|---|---|
| Name | Dk | mu (μ) | tanδe | @ 700 MHz | 1 GHz | @ 1.8 GHz | @ 2.7 GHz |
| Sample-P | 5.8 | 2 | 0.005 | 0.025 | 0.03 | 0.15 | 0.35 |
| Sample-P′ | 2.9 | 1 | 0.005 | 0 | 0 | 0 | 0 |

With respect to Table-1:
f1 and f2 represent the lower and upper frequencies that define a maximum efficiency at 753 MHz with a 100 MHz bandwidth (BW) and a gain of −6 dBi, where more specific test values for the center frequency, F, and the bandwidth, % BW, are provided in the table;

F=(f1)+(f2−f1)/2;

BW=(100)*((f2−f1)/F,
where dF is the bandwidth for Sample-P, and dF′ is the bandwidth for Sample-P′;
L is the length of the respective sample in the z-direction, with the x and y-directions normalized to unity so that dimension L represents the volume of the respective magneto-dielectric material, where V is the volume of the first magneto-dielectric material of Sample-P, and V′ is the volume of the second magneto-dielectric material of Sample-P′;
RadEff is provided as a comparison showing that both Sample-P and Sample-P′ have comparable radiation efficiencies greater than 90%;
MinEff is the resulting minimum radiation efficiency associated with the bandwidth BW, where Z is the minimum efficiency of Sample-P, and Z′ is the minimum efficiency of Sample-P′;

FOM=(100*L)/(BW*MinEff),
where FOM is calculated Figure Of Merit associated with Sample-P and Sample-P′; and

(Normalized W)=FOM/(FOM of Sample-P),
where W=(FOM of Sample-P)/(FOM of Sample-P)=1, and where W′=(FOM of Sample-P′)/(FOM of Sample-P).

As can be seen from the analytical test results depicted in Table-1, an embodiment of the invention disclosed herein as Sample-P′ has a dimensionless material attribute W′ associated with operational characteristics of a second magneto-dielectric material 104.2 that is less than attribute W associated with operational characteristics of a known first magneto-dielectric material 104.1 of Sample-P. Furthermore, W′/W is found to be less than 0.66, an in an embodiment is less than 0.65.

It is contemplated that there are many magnetic and dielectric materials, and/or combinations thereof, that may be suitable for the second magneto-dielectric material 104.2 disclosed herein for a purpose disclosed herein, with one such material having the measurable material characteristics and operational characteristics as identified in Tables 1 and 2 above. Any and all such materials that fall within the ambit of the claims appended hereto are contemplated and considered to be within the scope of an invention disclosed herein.

An embodiment as disclosed herein may have one or more of the following advantages: an antenna system with an increase of the radiated power of the antenna for a given volume of the antenna, as compared to an existing antenna of similar volume but lower radiated power, or as compared to an existing antenna of similar radiated power but greater volume; an antenna with improved performance at a given volume as compared to an existing antenna in the same given volume.

In general, the disclosure can alternately comprise, consist of, or consist essentially of, any appropriate components herein disclosed. The disclosure can additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

The terms “a” and “an” do not denote a limitation of quantity, but rather denote the presence of at least one of the referenced item. The term “or” means “and/or” unless clearly indicated otherwise by context. “Optional” or “optionally” means that the subsequently described event or circumstance may or may not occur, and that the description includes instances where the event occurs and instances where it does not.

Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments.

In general, the compositions, methods, and articles disclosed herein can alternatively comprise, consist of, or consist essentially of, any ingredients, steps, or components herein disclosed. The compositions, methods, and articles can additionally, or alternatively, be formulated, conducted, or manufactured so as to be devoid, or substantially free, of any ingredients, steps, or components not necessary to the achievement of the function or objectives of the present claims.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges.

The terms “first,” “second,” and the like, “primary,” “secondary,” and the like, as used herein do not denote any order, quantity, or importance, but rather are used to distinguish one element from another. The terms “upper”, “lower”, “bottom”, and/or “top” are used herein, unless otherwise noted, merely for convenience of description, and are not limited to any one position or spatial orientation. The term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An antenna system, comprising:
a signal feed;
a magneto-dielectric material electromagnetically coupled with the signal feed; and
a radiator element electromagnetically coupled with the magneto-dielectric material and the signal feed;
wherein the signal feed, the magneto-dielectric material, and the radiator element define a combination having:
a fractional bandwidth X defined by (dF/F), where dF is a signal bandwidth of the antenna, and F is a center frequency of the signal associated with dF;
a volume-to-wavelength ratio Y defined by (V/λ) where V is a volume of the combination, and λ is a wavelength in free space associated with the signal; and
an efficiency defined by Z, the efficiency Z being a minimum efficiency associated with dF;
wherein a first of the combination has a dimensionless material attribute W associated with operational characteristics of a first of the magneto-dielectric material;
wherein W is equal to Y/(X*Z);
wherein the first magneto-dielectric material is further defined by operational characteristics corresponding to a set of operable parameters P1, P2, P3 and P4;
wherein with respect to operable parameter set P1, V is equal to a defined volume V1, dF is equal to a defined bandwidth dF1, and Z is equal to a defined efficiency Z1, Y is defined by Y1 which is equal to V1/λ, X is defined by X1 which is equal to dF1/F, and W is defined by W1 which is equal to Y1/(X1*Z1);
wherein with respect to operable parameter set P2, V is equal to a defined volume V2 that is less than V1, dF is equal to a defined bandwidth dF2 that is less than dF1, Z is equal to a defined efficiency Z2 that is substantially equal to Z1, Y is defined by Y2 which is equal to V2/λ, X is defined by X2 which is equal to dF2/F, and W is defined by W2 which is equal to Y2/(X2*Z2);
wherein with respect to operable parameter set P3, V is equal to a defined volume V3 that is less than V2, dF is equal to a defined bandwidth dF3 that is substantially equal to dF2, Z is equal to a defined efficiency Z3 that is less than Z2, Y is defined by Y3 which is equal to V3/λ, X is defined by X3 which is equal to dF3/F, and W is defined by W3 which is equal to Y3/(X3*Z3);
wherein with respect to operable parameter set P4, V is equal to a defined volume V4 that is greater than V3 and less than V1, dF is equal to a defined bandwidth dF4 that is greater than dF3 and substantially equal to dF1, Z is equal to a defined efficiency Z4 that is substantially equal to Z3, Y is defined by Y4 which is equal to V4/λ, X is defined by X4 which is equal to dF4/F, and W is defined by W4 which is equal to Y4/(X4*Z4);
wherein a second of the combination has a dimensionless material attribute W′ associated with operational characteristics of a second of the magneto-dielectric material having different operational characteristics relative to the first magneto-dielectric material;
wherein the second magneto-dielectric material is further defined by operational characteristics corresponding to a set of operable parameters P′;
wherein with respect to operable parameter set P′, V is defined by V′, dF is defined by dF′, Z is defined by Z′, Y is defined by Y′ which is equal to V′/λ, X is defined by X′ which is equal to dF′/F, and W′ is equal to Y′/(X′*Z′);
wherein X′ is equal to or greater than 1.3 MHz/450 MHz and equal to or less than 100 MHz/750 MHz, and
wherein operational characteristics of the second combination associated with the second magneto-dielectric material satisfy the following condition, 0<(W′/W)<(W/W).

2. The antenna system of claim 1, wherein:
W′/W is equal to or less than 0.66.

3. The antenna system of claim 1, wherein:
with respect to associated operable parameter set P1, P′ is defined by P1′, V′ is defined by V1′, dF′ is defined by dF1′, Z′ is defined by Z1′, Y′ is defined by Y1′ which is equal to V1′/λ, X′ is defined by X1′ which is equal to dF1′/F, and W′ is defined by W1′ which is equal to Y1′/(X1′*Z1′); and
W1′ is less than W1.

4. The antenna system of claim 1, wherein:
with respect to associated operable parameter set P2, P′ is defined by P2′, V′ is defined by V2′, dF′ is defined by dF2′, Z′ is defined by Z2′, Y′ is defined by Y2′ which is equal to V2′/λ, X′ is defined by X2′ which is equal to dF2′/F, W′ is defined by W2′ which is equal to Y2′/(X2′*Z2′); and
W2′ is less than W2.

5. The antenna system of claim 1, wherein:
with respect to associated operable parameter set P3, P′ is defined by P3′, V′ is defined by V3′, dF′ is defined by dF3′, Z′ is defined by Z3′, Y′ is defined by Y3′ which is equal to V3′/λ, X′ is defined by X3′ which is equal to dF3′/F, W′ is defined by W3′ which is equal to Y3′/(X3′*Z3′); and
W3′ is less than W3.

6. The antenna system of claim 1, wherein:
with respect to associated operable parameter set P4, P′ is defined by P4′, V′ is defined by V4′, dF′ is defined by dF4′, Z′ is defined by Z4′, Y′ is defined by Y4′ which is equal to V4′/λ, X′ is defined by X4′ which is equal to dF4′/F, W′ is defined by W4′ which is equal to Y4′/(X4′*Z4′); and
W4′ is less than W4.

7. The antenna system of claim 1, wherein:
with respect to associated operable parameter set P1, P′ is defined by P1′, V′ is defined by V1′, dF′ is defined by dF1′, Z′ is defined by Z1′, Y′ is defined by Y1′ which is equal to V1′/λ, X′ is defined by X1′ which is equal to dF1′/F, and W′ is defined by W1′ which is equal to Y1′/(X1′*Z1′); and W1′/W1 is equal to or less than 0.66;
with respect to associated operable parameter set P2, P′ is defined by P2′, V′ is defined by V2′ that is less than V1′, dF′ is defined by dF2′ that is less than dF1′, Z′ is defined by Z2′ that is substantially equal to Z1′, Y′ is defined by Y2′ which is equal to V2′/λ, X′ is defined by X2′ which is equal to dF2′/F, W′ is defined by W2′ which is equal to Y2′/(X2′*Z2′), and W2′/W2 is equal to or less than 0.66;
with respect to associated operable parameter set P3, P′ is defined by P3′, V′ is defined by V3′ that is less than V2′, dF′ is defined by dF3′ that is substantially equal to dF2′, Z′ is defined by Z3′ that is less than Z2′, Y′ is defined by Y3′ which is equal to V3′/λ, X′ is defined by X3′ which is equal to dF3′/F, W′ is defined by W3′ which is equal to Y3′/(X3′*Z3′), and W3′/W3 is equal to or less than 0.66;
with respect to associated operable parameter set P4, P′ is defined by P4′, V′ is defined by V4′ that is greater than V3′ and less than V1′, dF′ is defined by dF4′ that is greater than dF3′ and substantially equal to dF1′, Z′ is defined by Z4′ that is substantially equal to Z3′, Y′ is defined by Y4′ which is equal to V4′/λ, X′ is defined by X4′ which is equal to dF4′/F, W′ is defined by W4′ which is equal to Y4′/(X4′*Z4′), and W4′/W4 is equal to or less than 0.66.

8. The antenna system of claim 1, wherein the signal feed comprises one of:
first and second spring connections, wherein the first spring connection is a signal connection and the second spring connection is a ground connection;
a coaxial cable comprising a centrally disposed signal line, a dielectric surrounding the signal line, and a ground line disposed outboard of the dielectric;
a printed circuit board signal trace;
a capacitive coupling; and
a magnet coupling.

9. The antenna system of claim 8, wherein:
the printed circuit board signal trace comprises one of: a micro-strip; a substrate integrated waveguide; and, a coplanar waveguide.

10. The antenna system of claim 7, wherein:
V1 has a thickness dimension T1 that is equal to around 5 millimeters (mm);
V1′ has a thickness dimension T1′ that is equal to around 5 millimeters (mm);
dF1 is equal to or less than around 100 MHz;
dF1′ is equal to or less than around 100 MHz;
Z1 is greater than or equal to 25% and less than or equal to 90%; and
Z1′ is greater than or equal to 25% and less than or equal to 90%.

11. The antenna system of claim 7, wherein:
dF1 is equal to around 75 MHz; and
dF1′ is equal to around 75 MHz.

12. The antenna system of claim 7, wherein:
dF2 is equal to around 1.3 MHz; and
dF2′ is equal to around 1.3 MHz.

13. The antenna system of claim 1, wherein:
V3 has a thickness dimension T3 that is equal to or greater than 1 mm;
V3′ has a thickness dimension T3′ that is equal to or greater than 1 mm;
Z3 is equal to around 25%; and
Z3′ is equal to around 25%.

14. The antenna system of claim 7, wherein:
dF is equal to or greater than 1.3 MHz and equal to or less than 100 MHz;
dF′ is equal to or greater than 1.3 MHz and equal to or less than 100 MHz; and
F is equal to or greater than 450 MHz and equal to or less than 750 MHz.

15. The antenna system of claim 14, wherein:
dF is equal to or less than 75 MHz;
dF′ is equal to or less than 75 MHz.

16. The antenna system of claim 7, wherein:
the second magneto-dielectric material of the second combination has a permeability μ and a permittivity ε; and
an operational characteristic between antenna design at P1′ and antenna design at P2′ is proportional to the ratio of μ/ε.

17. The antenna system of claim 16, wherein:
the second magneto-dielectric material of the second combination has an electrical loss tangent tan δₑ and a magnetic loss tangent (tan δₘ); and
the operational characteristic between antenna design at P2′ and antenna design at P3′ is proportional to 1/(tan δₑ+tan δₘ).

18. The antenna system of claim 3, wherein the radiator element is a double dipole type resonator.

19. The antenna system of claim 4, wherein the radiator element is a patch type resonator.

20. The antenna system of claim 5, wherein the radiator element is a planar inverted F type resonator.

21. The antenna system of claim 6, wherein the radiator element is a dipole type resonator.

22. An Internet of Things (IoT) type device comprising one or more of the antenna system according to claim 1.

23. An antenna array system, comprising:
a plurality of the antenna system of claim 1, each antenna system of the plurality being disposed within a unit area defined by equal to or less than λ/4×λ/4.

24. The antenna array system of claim 23, wherein:
λ is the free space wavelength at 450 MHz.

25. The antenna array system of claim 23, wherein:
polarization diversity is utilized to improve the isolation and envelope correlation coefficient between least spatially separated neighboring elements, as compared to a like array absent such polarization diversity.

26. The antenna array system of claim 23, wherein:
the envelope correlation coefficient between two most correlated elements is between 0.05 and 0.5.

27. The antenna array system of claim 23, wherein:
the envelope correlation coefficient between two least correlated elements is between 0.01 and 0.3.

28. The antenna array system of claim 23, wherein:
the array comprises a number of the antenna system that is equal to or greater four and equal to or less than eight.

29. A method of designing an antenna system having a signal feed, a magneto-dielectric electromagnetically coupled with the signal feed, and a radiator element electromagnetically coupled with the magneto-dielectric material and the signal feed, wherein the signal feed, the magneto-dielectric material, and the radiator element define a combination, the method comprising:
defining a fractional bandwidth X being equal to (dF/F), where dF is a signal bandwidth of the antenna, and F is a center frequency of the signal associated with dF;
defining a volume-to-wavelength ratio Y being equal to (V/λ) where V is a volume of the combination, and λ is a wavelength in free space associated with the signal;
defining an efficiency Z, where the efficiency Z is a minimum efficiency associated with dF;
defining a dimensionless material attribute W associated with operational characteristics of a first of the magneto-dielectric material associated with a first of the combination, where W is equal to Y/(X*Z);
defining the first magneto-dielectric material by operational characteristics corresponding to a set of operable parameters P1, P2, P3 and P4;
wherein with respect to operable parameter set P1, V is equal to a defined volume V1, dF is equal to a defined bandwidth dF1, and Z is equal to a defined efficiency Z1, Y is defined by Y1 which is equal to V1/λ, X is defined by X1 which is equal to dF1/F, and W is defined by W1 which is equal to Y1/(X1*Z1);
wherein with respect to operable parameter set P2, V is equal to a defined volume V2 that is less than V1, dF is equal to a defined bandwidth dF2 that is less than dF1, Z is equal to a defined efficiency Z2 that is substantially equal to Z1, Y is defined by Y2 which is equal to V2/λ, X is defined by X2 which is equal to dF2/F, and W is defined by W2 which is equal to Y2/(X2*Z2);
wherein with respect to operable parameter set P3, V is equal to a defined volume V3 that is less than V2, dF is equal to a defined bandwidth dF3 that is substantially equal to dF2, Z is equal to a defined efficiency Z3 that is less than Z2, Y is defined by Y3 which is equal to V3/λ, X is defined by X3 which is equal to dF3/F, and W is defined by W3 which is equal to Y3/(X3*Z3);
wherein with respect to operable parameter set P4, V is equal to a defined volume V4 that is greater than V3 and less than V1, dF is equal to a defined bandwidth dF4 that is greater than dF3 and substantially equal to dF1, Z is equal to a defined efficiency Z4 that is substantially equal to Z3, Y is defined by Y4 which is equal to V4/λ, X is defined by X4 which is equal to dF4/F, and W is defined by W4 which is equal to Y4/(X4*Z4);
defining a dimensionless material attribute W′ associated with operational characteristics of a second of the magneto-dielectric material associated with a second of the combination, the second magneto-dielectric material having different operational characteristics relative to the first magneto-dielectric material;
defining the second magneto-dielectric material by operational characteristics corresponding to a set of operable parameters P′;
wherein with respect to operable parameter set P′, V is defined by V′, dF is defined by dF′, Z is defined by Z′, Y is defined by Y′ which is equal to V′/λ, X is defined by X′ which is equal to dF′/F, and W′ is equal to Y′/(X′*Z′);
wherein X′ is equal to or greater than 1.3 MHz/450 MHz and equal to or less than 100 MHz/750 MHz, and
wherein operational characteristics of the second combination associated with the second magneto-dielectric material satisfy the following condition, 0<(W′/W)<(W/W).

30. The method of claim 29, wherein:
with respect to associated operable parameter set P1, P′ is defined by P1′, V′ is defined by V1′, dF′ is defined by dF1′, Z′ is defined by Z1′, Y′ is defined by Y1′ which is equal to V1′/λ, X′ is defined by X1′ which is equal to dF1′/F, and W′ is defined by W1′ which is equal to Y1′/(X1′*Z1′); and W1′ is less than W1;
with respect to associated operable parameter set P2, P′ is defined by P2′, V′ is defined by V2′ that is less than V1′, dF′ is defined by dF2′ that is less than dF1′, Z′ is defined by Z2′ that is substantially equal to Z1′, Y′ is defined by Y2′ which is equal to V2′/λ, X′ is defined by X2′ which is equal to dF2′/F, W′ is defined by W2′ which is equal to Y2′/(X2′*Z2′), and W2′ is less than W2;
with respect to associated operable parameter set P3, P′ is defined by P3′, V′ is defined by V3′ that is less than V2′, dF′ is defined by dF3′ that is substantially equal to dF2′, Z′ is defined by Z3′ that is less than Z2′, Y′ is defined by Y3′ which is equal to V3′/λ, X′ is defined by X3′ which is equal to dF3′/F, W′ is defined by W3′ which is equal to Y3′/(X3′*Z3′), and W3′ is less than W3; and
with respect to associated operable parameter set P4, P′ is defined by P4′, V′ is defined by V4′ that is greater than V3′ and less than V1′, dF′ is defined by dF4′ that is greater than dF3′ and substantially equal to dF1′, Z′ is defined by Z4′ that is substantially equal to Z3′, Y′ is defined by Y4′ which is equal to V4′/λ, X′ is defined by X4′ which is equal to dF4′/F, W′ is defined by W4′ which is equal to Y4′/(X4′*Z4′), and W4′ is less than W4.

31. The method of claim 30, wherein:
wherein W1′/W1 is equal to or less than 0.66;
wherein W2′/W2 is equal to or less than 0.66;
wherein W3′/W3 is equal to or less than 0.66; and
wherein W4′/W4 is equal to or less than 0.66.
